(19) United States
(12) Patent Application Publication
(10) Pub. No.: US 2020/0253184 A1
(43) Pub. Date: Aug. 13, 2020

(54) SPRAYING DEVICE AND METHOD

(71) Applicant: Robert Bosch GmbH, Stuttgart (DE)

(72) Inventors: Jochen Glasbrenner, Stuttgart (DE); Helmut Schomburg, Deufringen (DE); Olaf Ohlhafer, Erligheim (DE); Steffen Sies, Rottenburg (DE); Dieter Amesoeder, Ludwigsburg (DE); Hans-Arndt Freudigmann, Tuebingen (DE)

(21) Appl. No.: 16/760,283

(22) PCT Filed: Oct. 26, 2018
(86) PCT No.: PCT/EP2018/079370

§ 371 Date: Apr. 29, 2020

(30) Foreign Application Priority Data
Nov. 10, 2017 (DE) 10 2017 220 028.6

(51) Int. Cl. A01M 7/00; B05B 7/32; B05B 12/14; B05B 13/00; B05B 15/40

(52) U.S. Cl. CPC A01M 7/0092; B05B 7/32; A01M 7/0042; B05B 13/005; B05B 15/40; B05B 12/1418

(57) ABSTRACT

A spraying device for deploying liquids for agricultural purposes. The spraying device includes at least one spray nozzle for spraying the liquid and at least one mixing device, which includes at least one mixing chamber, at least one first inflow for a carrier liquid, at least two second inflows for different active agent liquids, and at least one outflow connected to the spray nozzle, connecting to the mixing chamber. It is provided that an actuatable valve is associated with each of the inflows. A device is also provided which actuates the valves during intended use in such a way that a constant volume flow results in the outflow regardless of the actuation of the valves/switching of the inflows.

### FIELD

The present invention relates to a spraying device for deploying liquids, in particular for agricultural purposes, including at least one spray nozzle for spraying the liquid and including at least one mixing device, which includes at least one mixing chamber, the mixing chamber including at least one first inflow for a carrier liquid, at least two second inflows for an active agent liquid, and at least one outflow connected to the at least one spray nozzle.

Furthermore, the present invention relates to a method for operating such a spraying device.

### BACKGROUND INFORMATION

In present agricultural plant protection measures, the spray mixture, including at least one active agent, in particular an active agent liquid, for example, plant protection agents, and a carrier liquid, in particular water, has to be premixed before the actual application to a field. At the end of the application, the tank providing the particular agent generally has to be completely emptied and cleaned on the field. A reaction to the condition of the field and to the actual local need for plant protection agents is therefore hardly possible. All of the mixed spray mixture is therefore deployed completely on the field.

In some convention systems, the active agent liquids are carried along undiluted in a separate tank and only mixed with the carrier liquid during the deployment onto the field on demand.

For this mixing procedure, it is necessary to be able to meter the active agent liquid with the carrier liquid as needed. This metering procedure is also referred to as direct feed and requires a complex structure of a spraying device, which has to provide valves and the like required for this purpose.

Such spraying devices are available in the related art. For example, German Patent Application No. DE 10 2006 059 193 A1 describes a spraying device which includes a mixing chamber to which a carrier liquid and an active agent liquid, in particular a plant protection agent, may be supplied. It is provided that initially the active agent liquid is fed into at least one bypass line for pre-dilution, the bypass line, which contains active agent pre-diluted using the carrier liquid, connecting to a carrier liquid line leading to multiple spray nozzles. To influence the mixing or the ratio of carrier liquid to active agent liquid, multiple outlet valves or adjusting valves activatable independently of one another are provided, each including a valve element as a control member, which are connected upstream from the liquid lines forming the mixing chamber.

A further spraying device is described, for example, in German Patent Application No. DE 31 40 441 A1, including a metering pump, which is designed as a piston pump, carrier liquid and active agent liquid being combined in the metering pump, so that the metering pump itself acts as a mixing device having a mixing chamber and the pistons act as control members.

Furthermore, a spraying device is described in German Patent Application No. DE 39 08 963 A1, including metering pumps which pump both the active agent liquid and the carrier liquid on demand into a mixing chamber in a desired mixing ratio.

### SUMMARY

An example spraying device according to the present invention may have the advantage that a rapid and situation-suitable plant protection measure may be carried out, it being ensured that the total deployed quantity and/or the volume flow supplied to the at least one spray nozzle remains constant regardless of the number of the metered active agent liquids. An optimum application of the plant protection agent to a field is ensured in this way. For this purpose, it is provided according to an example embodiment of the present invention that an actuatable valve is associated with each of the inflows, and the spraying device includes a device which actuates the valves in the case of intended use in such a way that a constant volume flow results in the process regardless of the actuation of the valves or the circuitry of the inflows.

According to one preferred refinement of the present invention, it is provided that the valves associated with the inflows are each designed identically. A high number of identical parts results in this way, which ensures simple assembly and cost-effective provision of the spraying device. In addition, it is achieved that due to the identical design of the valves, the valves each have the same flow resistance and also provide the same flow cross sections.

Furthermore, it is preferably provided that a pump device for delivering the particular liquid is connected upstream from each valve, the pump devices being designed to each provide the same delivery pressure. This is not to mean that a separate pump device has to be connected upstream from each valve. Rather, this is to mean that one shared pump device may also be connected upstream from multiple valves. However, in accordance with an example embodiment of the present invention, it is important that a pump device, whether shared or alone, is connected upstream from every valve to provide the desired delivery pressure at the particular valve. Therefore, in particular one pump device is connected upstream in each case from the valves having a shared supply line. In particular, it is provided that the pump devices are designed identically. By ensuring the same delivery pressure, the valves each provide the same flow volume. This applies both to the inflows of the active agent liquid and to the at least one inflow for the carrier liquid. The total volume flow is thus maintained if, for example, one valve is closed and another valve is opened.

Furthermore, it is preferably provided that the mixing device includes three second inflows for three different active agent liquids. The mixing device therefore includes at least four inflows in total. Different switching combinations may thus be achieved, in the case of each of which one or more active agent liquids are mixed with the carrier liquid and switching over between active agent liquids may take place without the total volume flow which flows through the outflow changing in this way.

According to one particularly preferred refinement of the present invention, it is provided that the mixing device includes two first inflows for the carrier liquid. Because two first inflows are also provided for the carrier liquid, metering of the carrier liquid is also possible by switching on and off the two valves associated with the two first inflows. The variety of variants of the mixing device is increased in this way, with constant output volume flow.

The example device is preferably designed to operate mechanically and includes for this purpose at least one camshaft, arranged in the mixing chamber, for mechanically actuating the valves. It is thus ensured that the valves are always actuated simultaneously by movement of the camshaft, whereby it is ensured that the total delivery volume always flows through the outflow. The cam curves of the camshaft are selected appropriately for this purpose. The particular valve preferably includes a movably-mounted valve element, which is spring-loaded in the direction of the camshaft and which, in a state unactuated by the camshaft, presses against a valve seat of the valve to seal the affected access closed. The particular valve thus includes a movable valve element which, in the normal state or a state in which it is not actuated by the camshaft, presses against a valve seat to form a seal, and thus closes the affected or associated inflow/access. By pivoting the camshaft, the valve element is displaced by the camshaft against the spring force, so that it assumes a distance to the valve seat, whereby the flow cross section is released and active agent liquid or carrier liquid may flow through the access thus opened. It is ensured by the spring pre-tension that the valve element always returns reliably back to the valve seat and positive guiding for the valve element is provided on the camshaft.

Furthermore, it is preferably provided that an activatable actuator is associated with each valve, and that the device is designed to electrically activate the actuators. In this case, the constant output volume flow is not ensured by the mechanism provided in the mixing device, but rather by an electrical activation of the actuators with the aid of the device. The device preferably includes a control unit for this purpose, in particular a microprocessor, which adopts the activation of the actuators as a function of a required plant protection measure.

Furthermore, it is preferably provided that the device is designed to actuate the actuators with the aid of a pulse-width-modulation activation. Due to the pulse-width-modulation activation, intermediate positions of the valves are also achievable, so that, for example, a flow cross section is not released completely, but rather is still released partially by the particular valve. A further influence of the mixing ratios of the active agent liquids and the carrier liquids is thus possible.

According to one preferred refinement of the present invention, the mixing device includes a housing, which includes a mixing borehole, into which the inflows open. The mixing chamber is thus formed by a mixing borehole into which the inflows each open, and from which the outflow advantageously also discharges. The mixing chamber is also manufactured in a particularly cost-effective and simple way by the mixing borehole.

Furthermore, it is preferably provided that at least one solid body is situated in the mixing borehole to reduce the mixing volume. With increasing mixing volume, the time also increases for cleaning and flushing out the mixing chamber after a completed plant protection agent application. Due to the integration of a solid body into the mixing borehole, this volume is reduced, so that the flushing out or the cleaning is also facilitated and optimized.

The solid body is particularly preferably designed as a static mixer. In this way, the thorough mixing of the active agent liquids with the carrier liquid is improved and an optimum application result is achieved. The active agent liquids are preferably already prediluted, to increase the deployment amount overall.

Furthermore, it is preferably provided that a filter element is provided. Due to the filter, particles or other solids which could contaminate the mixing chamber and the spray nozzles and clog them in the worst case are prevented from penetrating into the mixing chamber. The service life of the spraying device is thus lengthened. In particular, maintenance cycles may thus be shortened.

In accordance with an example embodiment, an example method provides that the valves of the mixing device are actuated in such a way that during a plant protection agent application procedure, in which the mixing ratio is changed in the mixing chamber, the same volume flow is always supplied to one or multiple spray nozzles through the outflow. The above-mentioned advantages are achieved in this way.

Further advantages and preferred features and feature combinations result in particular from the description herein.

The present invention is explained in greater detail hereafter on the basis of the figures.

### BRIEF DESCRIPTION OF THE DRAWINGS

FIG. 1 shows an advantageous spraying device in a simplified representation.

FIG. 2 shows a schematic detail view of the spraying device.

FIG. 3 shows a schematic representation of an advantageous mixing device of the spraying device.

FIG. 4 shows a further exemplary embodiment of the advantageous spraying device.

FIGS. 5A through 5C show the mixing device in different views.

FIG. 6 shows a detail sectional representation of the mixing device.

FIGS. 7A and 7B show variants of the mixing device in perspective representations.

FIGS. 8A through 8D show further variants of the mixing device in different views.

### DETAILED DESCRIPTION OF EXAMPLE EMBODIMENTS

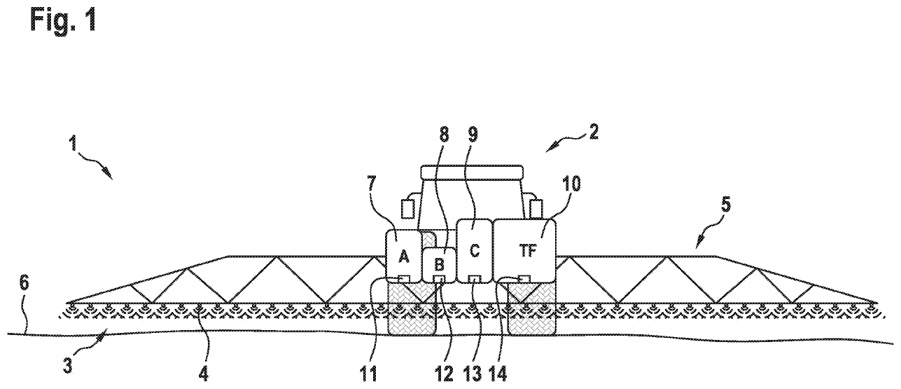

FIG. 1 shows a simplified representation of a spraying device 1, which includes a vehicle 2 designed as a tractor, which supports a spraying system 3, including a plurality of spray nozzles 4, spray nozzles 4 being situated distributed adjacent to one another over a crossbeam 5. Vehicle 2 pulls crossbeam 5 and spray nozzles 4 behind it, so that these spray nozzles are located above a ground 6, to apply plant protection agent to the ground and plants possibly located thereon. Vehicle 2 additionally supports multiple tanks 7, 8, 9, and 10, a liquid active agent A, B, or C, being stored in tanks 7, 8, and 9, respectively, and a carrier liquid TF, in particular in the form of water, being stored in tank C. Tanks 7 through 10 are connected to spray nozzles 4 by one or multiple mixing devices, which are to be discussed in greater detail hereafter. To deliver the particular liquid, a pump device 11, 12, 13, and 14 is associated with each tank, with the aid of which the particular liquid is removable and suppliable to the mixing device described hereafter. While three different active agent tanks 7, 8, and 9 are shown and described in the following exemplary embodiment, however, spraying device 1 may also include more or fewer active agent tanks.

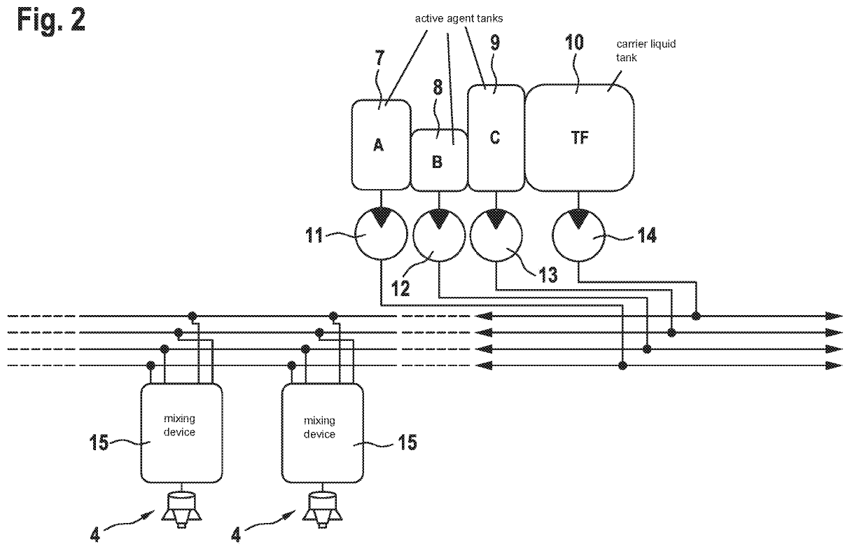

FIG. 2 shows a simplified detail view of spraying device 1, in which four tanks 7, 8, 9, and 10, associated pump devices 11 through 14, and two of spray nozzles 4 are shown. A mixing device 15, each of which is connected to pump devices 11, 12, 13, and 14 by corresponding fluid lines, is connected upstream from each of spray nozzles 4. Therefore, the particular liquid is applicable to each of mixing devices 15, mixing device 15 being designed to set a desired mixing ratio of the individual liquids to one another and supply it to particular spray nozzle 4.

The spray mixture to be provided by mixing device 15 is made up of the carrier liquid and a plant protection agent, for example, A, B, or C, or of a combination thereof. The composition of the spray mixture is typically in the range of 25 to 200 volume portions carrier liquid to one volume portion of the plant protection agent for liquid plant protection agents and for solid plant protection agents in the range of 50 to 20,000 mass portions carrier liquid to one mass portion plant protection agent. Values differing therefrom are also possible, of course. Because mixing device 15 is connected upstream from particular spray nozzle 4 in each case, the advantage results that mixing of the individual liquids only takes place shortly before the spray nozzle, so that, on the one hand, each spray nozzle may emit an individual composition of the spray mixture, and, on the other hand, the volume which has to be removed from the lines of spraying device 1 following a plant protection agent application to clean the components thereof is kept particularly small.

While in the present case mixing devices 15 are connected directly upstream from a spray nozzle 4, it is provided according to another exemplary embodiment that only one mixing device 15 is connected upstream from each partial width, i.e., a predetermined number of spray nozzles 4 situated adjacent to one another, so that each partial width of spray nozzles 4 applies the same spray mixture to the field. It may also be provided that mixing device 15 is connected directly downstream from tanks 7, 8, 9, 10 or pump device 11 through 14 thereof, to produce the desired spray mixture early and supply it to all spray nozzles 4 of spraying device 1. In addition, for individual nozzle switching, each spray nozzle 4 is optionally equipped with a simple switching valve, which easily enables activation and deactivation of the particular spray nozzle.

In the case of a typical application of plant protection agent including a carrier liquid, it is necessary to keep the total application amount constant, in particular the amount of carrier liquid. Thus, for example, when switching over from, for example, one plant protection agent to a combination of multiple plant protection agents, the total application amount per spray nozzle 4 or per unit of area to be sprayed is to remain constant. Due to the advantageous design of spraying device 1, it is now possible to supply a constant volume flow to the particular spray nozzle, regardless of which combination of plant protection agents and carrier liquid is selected, and whether this combination is changed during the operation.

For this purpose, it is provided that pump devices 11 through 14 are designed to provide the same volume flow and/or the same fluid pressure, so that a constant or the same volume flow for all liquids results from each of pump devices 11 through 14. It is thus also ensured that an optimum drop size is ensured at particular spray nozzle 4 for the plant protection agent application. Due to the advantageous design, the drop size or the drop size spectrum also remains the same, even if a selection is made between the plant protection agents. This is to be discussed in greater detail hereafter.

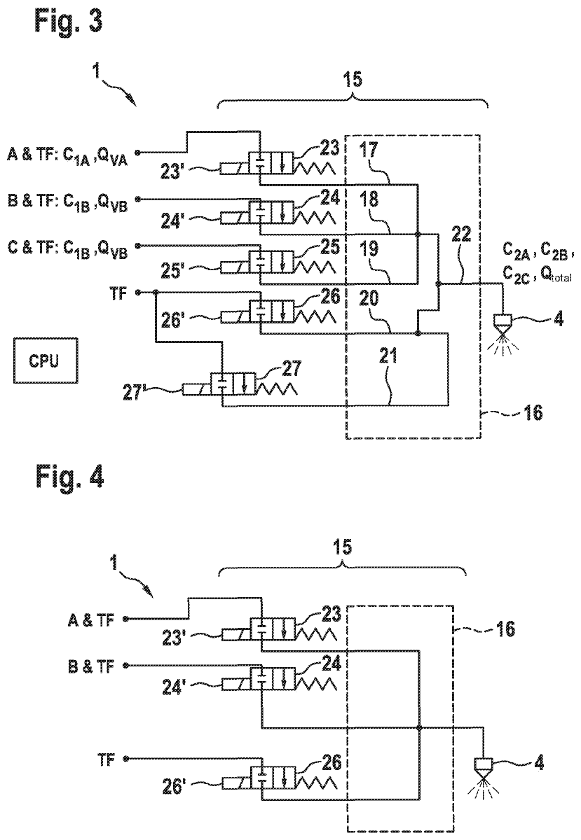

FIG. 3 shows mixing device 15 in a schematic representation for this purpose. It includes a mixing chamber 16, in which the various liquids may be mixed with one another. Mixing chamber 16 includes multiple inflows 17 through 21 for this purpose, as well as at least one outflow 22 leading to spray nozzles 4.

A valve 23, 24, 25, 26, and 27 is associated with each of inflows 17 through 21, which may close, release, or partially release the flow cross section of particular inflows 17 through 21. For this purpose, valves 23 through 27 are designed to be electrically activatable. In particular, valves 23 through 27 each include an actuator 23′, 24′, 25′, 26′, and 27′ for moving an adjustable valve element, which is movable against the force of a restoring spring. Valves 23 through 27 are shown in simplified form in FIG. 3. Valve 23 is connected between pump device 11 and mixing chamber 16, valve 24 between pump device 12 and mixing chamber 16, valve 25 between pump device 13 and mixing chamber 16, and valves 26 and 27 are each connected between pump device 14 and mixing chamber 16. Therefore, in each case the carrier liquid or the volume flow of the carrier liquid into mixing chamber 16 is settable by each of valves 26, 27, while active agent liquids A, B, and C are each settable using valves 23, 24, and 25. The active agent liquids are advantageously already stored pre-diluted with the carrier liquid in tank 7, 8, 9 or are provided via a suitable pre-mixing system.

In the present case, valves 23 through 27 are designed to be identical and are combined with one another by a control unit CPU by activating actuators 23′ through 27′ in such a way that a constant volume flow Q_{ges} is always provided at outflow 22. This is achieved in that, on the one hand, the same pressure exists in the supply lines, i.e., on the pressure side of particular pump device 11 through 14.

In the following table, in the first column different combinations of plant protection agents A, B, and C with carrier liquid TF and corresponding switching combinations for achieving volume flow Q_{ges} are listed. In the five columns arranged thereafter, the basic switch positions of individual valves 23 through 27 are shown. “ON” stands for a completely open valve and “OFF” stands for a completely closed valve:

| | valve | valve | valve | valve | valve |
|---|---|---|---|---|---|
| | 23 | 24 | 25 | 26 | 27 |
| A + TF | ON | OFF | OFF | ON | ON |
| B + TF | OFF | ON | OFF | ON | ON |
| C + TF | OFF | OFF | ON | ON | ON |
| A + B + TF | ON | ON | OFF | ON | OFF |
| A + C + TF | ON | OFF | ON | ON | OFF |
| C + B + TF | OFF | ON | ON | ON | OFF |
| A + B + C + TF | ON | ON | ON | OFF | OFF |

A switching combination 26=ON and valve 27=OFF may alternatively be represented via the switching combination valve 26=OFF and valve 27=ON.

The hydraulic resistances of individual valves 23 through 27 are also identical due to their identical design. Therefore, for the switching combinations shown in the table, a third of total volume flow Q_{ges} flows via the particular open valves. Volume flow Q_{ges} through one spray nozzle 4 is typically predefined for an application. Furthermore, concentration C₂, i.e., the volume of the particular component divided by the total volume and a reference element (a constant density and molar mass are presumed), of individual plant protection agents A, B, C is also predefined. In order that the setpoint concentration is maintained for the individual switching combinations, plant protection agents A, B, C are diluted with the aid of carrier liquid TF to a concentration C₁. Particular concentration C₁ for the represented switch plan in the above-mentioned table corresponds to three times final concentration C₂.

If, for example, total volume flow Q_{ges} is established at 3 L/min and the concentrations of individual plant protection agents A, B, C are established as follows: C_{2A}=0.01, C_{2B}=0.02, and C_{2C}=0.001, the following volume flows thus result around concentrations C₁ for the individual switching combinations in the above-mentioned table:

| | Q_{ges} | | | | Q_{VA} | Q_{VB} | Q_{VC} | Q_{VTF1} | Q_{VTF2} | | | |
|---|---|---|---|---|---|---|---|---|---|---|---|---|
| | in | | | | in | in | in | in | in | | | |
| | l/min | C_{2A} | C_{2B} | C_{2C} | l/min | l/min | l/min | l/min | l/min | C_{1A} | C_{1B} | C_{1C} |
| A + TF | 3 | 0.01 | 0 | 0 | 1 | 0 | 0 | 1 | 1 | 0.03 | — | — |
| B + TF | 3 | 0 | 0.02 | 0 | 0 | 1 | 0 | 1 | 1 | — | 0.06 | — |
| C + TF | 3 | 0 | 0 | 0.001 | 0 | 0 | 1 | 1 | 1 | — | — | 0.003 |
| A + B + | 3 | 0.01 | 0.02 | 0 | 1 | 1 | 0 | 1 | 0 | 0.03 | 0.06 | — |
| TF | | | | | | | | | | | | |
| A + C + | 3 | 0.01 | 0 | 0.001 | 1 | 0 | 1 | 1 | 0 | 0.03 | — | 0.003 |
| TF | | | | | | | | | | | | |
| C + B + | 3 | 0 | 0.02 | 0.001 | 0 | 1 | 1 | 1 | 0 | — | 0.06 | 0.003 |
| TF | | | | | | | | | | | | |
| A + B + | 3 | 0.01 | 0.02 | 0.001 | 1 | 1 | 1 | 0 | 0 | 0.03 | 0.06 | 0.003 |
| C + TF | | | | | | | | | | | | |

It is possible to reduce the volume flow through individual valves 23 through 27 with the aid of a pulse-width-modulated activation of actuators 23′ through 27′. It is thus possible to vary the concentration at the outflow of the mixing device in spite of predefined concentrations at the inflow of mixing device 15. Furthermore, it is possible to activate or vary the total volume flow with the aid of pulse-width modulation. This is provided, for example, when negotiating curves, since in such a case the relative velocities of spray nozzles 4 over ground 6 differ. To be able to deploy a constant quantity of carrier liquid and plant protection agent per unit of area, the total volume flow through particular spray nozzles 4 with the aid of mixing device 15 is adapted by the pulse-width modulation.

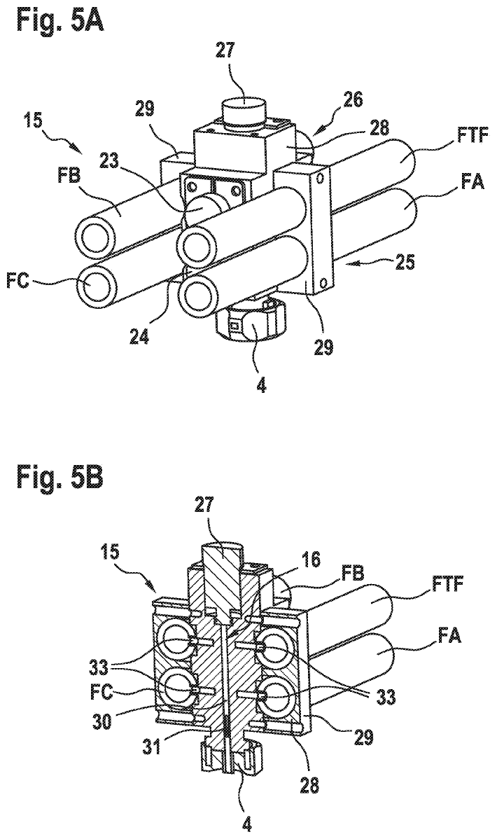

A variant of the exemplary embodiment of mixing device 15 shown in FIG. 3 is shown in FIG. 4. Therefore, the variant shown in FIG. 4 differs from the exemplary embodiment in FIG. 3 in that only two different plant protection agents A and B and also only one connection to tank 10 having carrier liquid TF are provided. In this case, the concentration of plant protection agent to carrier liquid at the inlet corresponds to twice the concentration at the outlet of mixing device 15.

Different exemplary embodiments for mixing device 15 will be explained in greater detail hereafter.

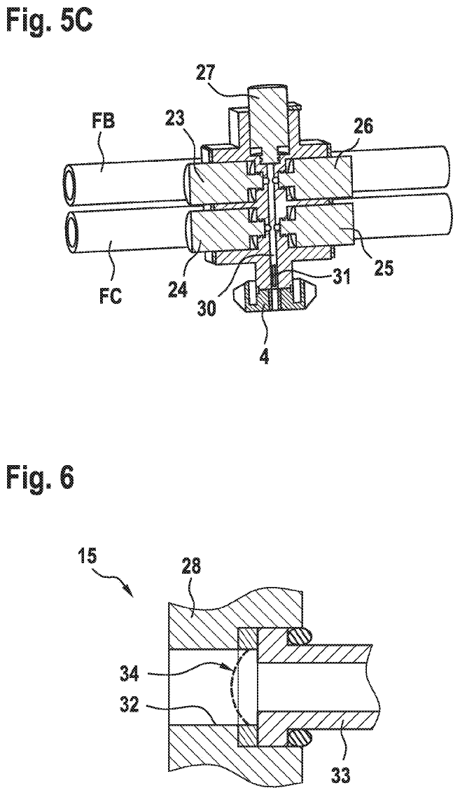

FIG. 5 shows for this purpose a first exemplary embodiment of mixing device 15. Mixing device 15 includes the five valves 23 through 27, which are situated on a housing 28 forming mixing chamber 16. In housing 28, fluid channels extend into mixing chamber 16 through valves 23 through 27, the internal fluid channels being connected to fluid lines FA, FB, FC, and FTF, which are each connected to the pressure side of one of pump devices 11 through 14 in order to correspondingly supply carrier liquid TF, or plant protection agents A, B, and C, to mixing device 15. Valves 23 through 27 are designed in the present case to be cartridge valves or 2/2-way valves. Fluid-conducting lines FTF, FA, FB, and FC are fastened in the present case with the aid of two retaining brackets 29 at housing 28. The advantage of a simple installation and a compact construction of mixing device 15 results in this way.

While FIG. 5A shows the mixing device in a perspective representation, FIGS. 5B and 5C show mixing device 15 in different sectional representations, the planes of section being perpendicular to one another. The individual flow paths extend through valves 23 through 27, the flow path for carrier liquid TF being divided and leading through two individual valves 26 and 27, as already explained above and shown in FIG. 3. Valves 26, 27 at the head of housing 28 are preferably the valves for the carrier liquid. It is thus possible to flush out entire mixing borehole 30 for cleaning using the carrier liquid. The head of mixing borehole 30 is thus understood as the end of mixing borehole 30, which forms mixing chamber 16, formed in housing 28 facing away from spray nozzle 4.

Downstream from valves 23 through 27, the flow paths meet in mixing borehole 30, so that the liquids mix with one another. The diameter of mixing borehole 30 advantageously corresponds to only a few millimeters or less. The volume of mixing borehole 30 determines the time after which a mixture changed in the mixing borehole is dispensed from the mixing borehole and spray nozzle 4. The less the volume is in mixing borehole 30, the shorter is the period of time between switching over valves 23 through 27 and providing the desired spray mixture at associated spray nozzle 4. A suitable solid body 31 is preferably situated in the mixing borehole to reduce the volume of mixing borehole 30. Solid body 31 is advantageously a static mixer, which improves the mixing of the individual liquids within the mixing borehole.

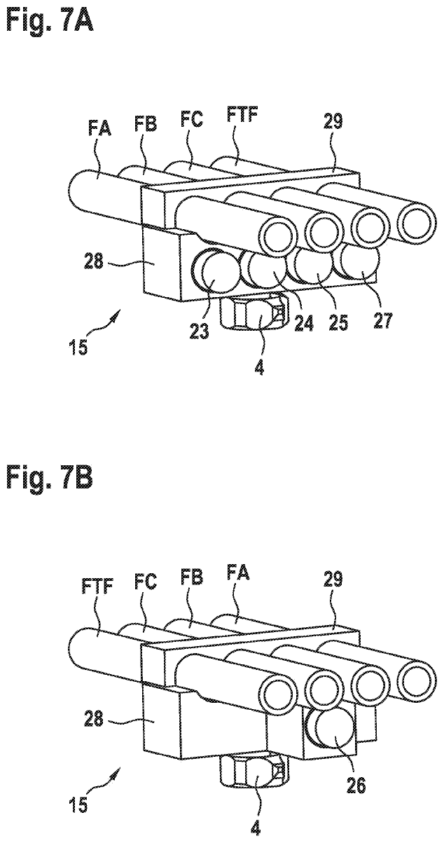

FIG. 6 shows an advantageous refinement of mixing device 15 on the basis of a detailed sectional representation. Housing 28 is shown in FIG. 6 having an inflow opening 32 formed thereon, which forms inflow 17, for example, and a supply nipple 33, which is associated with inflow opening 32, of the fluid line associated with this inflow. Supply nipple 33 connects one of the fluid lines, in the present case fluid line FA, to mixing device 15. For this purpose, the supply nipple projects transversely into fluid line FA, so that a fluidic connection is established between mixing device 15 and fluid line FA. To protect the individual valves and spray nozzle 4 from soiling and particles, it is provided in the present case that a filter element 34 is either integrated into supply nipple 33 or is axially clamped or held between the supply nipple and housing 28.

The arrangement of fluid-conducting supply lines FA, FB, FC, and FTF on mixing device 15 and the arrangement of valves 23 through 27 may also be implemented in further variants in addition to the embodiment shown in FIG. 5. Further examples are shown for this purpose in FIGS. 9 and 10.

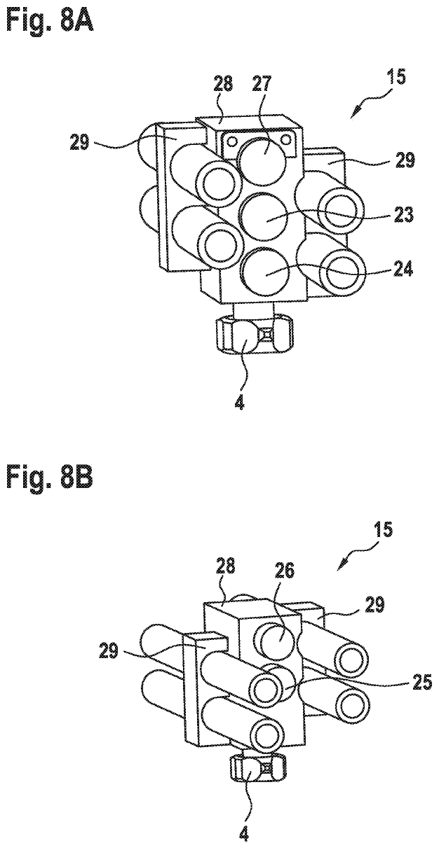

FIGS. 7A and 7B show two exemplary embodiments for this purpose, in which the fluid lines are situated adjacent to one another on one side of mixing device 15 or housing 28. Four of the valves are situated on one side and the fifth valve is situated on the other side of mixing device 15. Fluid lines FA through FTF are held by a shared holding clamp 29 at housing 28.

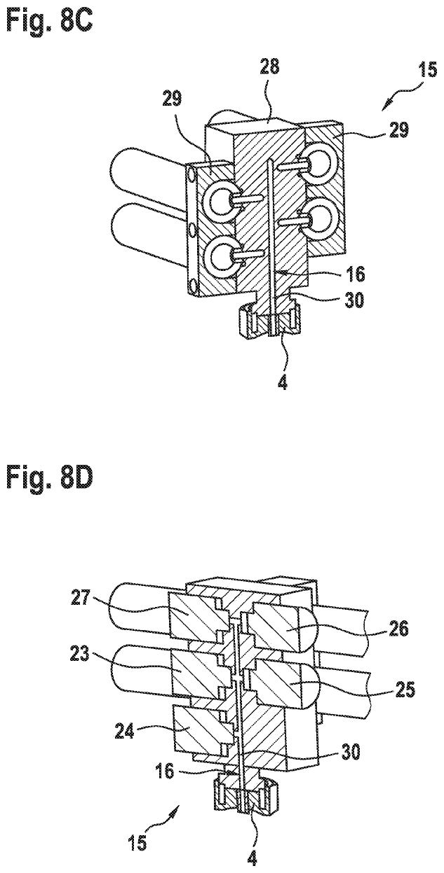

FIGS. 8A through 8D show further exemplary embodiments which differ from the preceding exemplary embodiments in that fluid lines FA through FTF are situated on two sides of housing 28, but are located offset in relation to one another in height. FIGS. 8A and 8B show mixing device 15 in the perspective front view and in a rear view for this purpose, and FIGS. 8C and 8D show mixing device 15 according to this exemplary embodiment in two different sectional representations, the planes of section being perpendicular to one another.

1-13. (canceled)

14. A spraying device for deploying liquids for agricultural purposes, the spraying device comprising:
at least one spray nozzle configured to spray the liquid;
at least one mixing device, including at least one mixing chamber, at least one first inflow for a carrier liquid, at least two second inflows for different active agent liquids, and at least one outflow connected to the spray nozzle, the first and second inflows leading into the mixing chamber and the outflow leading out from the mixing chamber, wherein a respective actuatable valve is associated with each of the first and second inflows; and
a device configured to actuate the respective valves during use in such a way that a constant volume flow results in the outflow regardless of the actuation of the respective valves and switching of the first and second inflows.

15. The spraying device as recited in claim 14, wherein the respective valves associated with the first and second inflows are each designed to be identical to one another.

16. The spraying device as recited in claim 14, further comprising:
a respective pump device configured to deliver liquid is connected upstream from each of the respective valves, the pump devices being configured to each provide the same delivery pressure relative to one another.

17. The spraying device as recited in claim 14, wherein the mixing device the at least two second inflows include three second inflows for three different active agent liquids, which are prediluted.

18. The spraying device as recited in claim 14, wherein the at least one first inflow includes two first inflows for the carrier liquid.

19. The spraying device as recited in claim 14, wherein the device is configured to operate mechanically and includes at least one camshaft, arranged in the mixing chamber, for mechanically actuating the respective valves.

20. The spraying device as recited in claim 14, wherein a respective activatable actuator is associated with each of the respective valves, and the device is configured to electrically activate the respective actuators.

21. The spraying device as recited in claim 20, wherein the device is configured to actuate the respective actuators using pulse-width-modulation activation.

22. The spraying device as recited in claim 14, wherein the mixing device includes a housing which includes a mixing borehole, into which the first and second inflows open.

23. The spraying device as recited in claim 22, wherein at least one solid body for reducing the mixing volume is situated in the mixing borehole.

24. The spraying device as recited in claim 23, wherein the solid body is a static mixer.

25. The spraying device as recited in claim 14, wherein a respective filter element is associated with at least one of the first and second inflows.

26. A method for operating a spraying device for deploying liquids for agricultural purposes, the spraying device including at least one spray nozzle configured to spray the liquid, at least one mixing device, including at least one mixing chamber, at least one first inflow for a carrier liquid, at least two second inflows for different active agent liquids, and at least one outflow connected to the spray nozzle, the first and second inflows leading into the mixing chamber and the outflow leading out from the mixing chamber, wherein a respective actuatable valve is associated with each of the first and second inflows, and a device configured to actuate the respective valves during use in such a way that a constant volume flow results in the outflow regardless of the actuation of the respective valves and switching of the first and second inflows, the method comprising:
actuating the respective valves in such a way that the same volume flow is always conducted to one or multiple of the at least one spray nozzle by the outflow.
